(19) United States
(12) Patent Application Publication
(10) Pub. No.: US 2019/0112035 A1
(43) Pub. Date: Apr. 18, 2019

(54) LANDING GEAR BAY ROOF COMPRISING AT LEAST ONE GANTRY INSTALLED AGAINST A LOWER FACE OF ITS WALL

(71) Applicants: Airbus Operations SAS, Toulouse (FR); Stelia Aerospace, Rochefor (FR)

(72) Inventors: Daniel BELLET, SAINT-LYS (FR); Francois LOYANT, L'ISLE JOURDAIN (FR); Alexandra LEGARDEZ, CLERMONT SAVES (FR); Simon ROUX, TOULOUSE (FR); Sebastien CROUZET, TOULOUSE (FR); Laurent DUBREUIL, PIBRAC (FR); Alain PRUDENT, MONTBRUN LAURAGAIS (FR)

(21) Appl. No.: 16/161,394

(22) Filed: Oct. 16, 2018

(30) Foreign Application Priority Data
Oct. 17, 2017 (FR) 1759721

(51) Int. Cl. B64C 25/02

(52) U.S. Cl. CPC B64C 25/02

(57) ABSTRACT

An aircraft landing gear bay roof, the roof forming a pressurization barrier between a pressurized upper compartment and a landing gear bay for the housing of a landing gear, comprising a roof wall forming the pressurization barrier. The roof wall is held by longitudinal gantries to which it is linked, and which extend over the entire length of the roof wall. The roof wall comprises a lower face configured to be installed inside the landing gear bay and an upper face configured to be installed outside the landing gear bay. At least one of the gantries is installed against the lower face of the roof wall.

### CROSS-REFERENCES TO RELATED APPLICATIONS

This application claims the benefit of the French patent application No. 1759721 filed on Oct. 17, 2017, the entire disclosures of which are incorporated herein by way of reference.

### BACKGROUND OF THE INVENTION

The present invention relates to the structure of aircraft, in particular at the landing gear level thereof. It relates, in particular, to a main landing gear bay, and relates more specifically to the roof of such a landing gear bay.

On most aircraft known from the state of the art, in particular the commercial passenger or goods transport aircraft, the main landing gear bay is formed under the fuselage of the aircraft, at a longitudinal position situated in proximity to the trailing edge of the main wing of the aircraft.

The main gear bay roof is intended firstly to ensure the separation between the pressurized upper compartment and the lower compartment forming the gear bay for the housing of the main landing gear.

This non-pressurized gear bay is delimited to the front by a central wing box and to the rear by the baggage compartment.

The gear bay roof is generally connected to the upper panel of the central wing box. Because of this, the bay roof must withstand the deformations of the central wing box. Thus, the gear bay roof must be sufficiently flexible in the transverse direction of the aircraft to limit the negative consequences of these deformations.

Furthermore, some main landing gear configurations developed in recent years require the mechanical forces to which the gear is subjected to be taken up not only by the structure of the wing alone, but also by the fuselage of the aircraft.

Also, a landing gear bay configuration with flexible roof can prove unsuitable when the roof has to take up mechanical forces originating directly from structural elements of the landing gears, like the strut.

In response to this issue, the document FR3031080 discloses a main landing gear bay comprising a roof comprising a first and a second reinforced structure, spaced apart from one another in a transverse direction of the roof, and a membrane linking the first and the second reinforced structures. According to this configuration, the first and the second reinforced structures make it possible to take up forces imposed by a structural element of a landing gear which is respectively linked to them, and for this force to be transmitted to the structure of the fuselage, while the membrane allows the deformations provoked by the central wing box.

Nevertheless, it is necessary in an aircraft to run a certain number of systems, in ducts or conduits that have to run longitudinally in the landing gear bay. It is thus advantageous to optimize the landing gear bay configurations known from the state of the art (and in particular of the landing gear bay roof) in order to allow an easy passage of such systems, but without degrading the mechanical characteristics of the bay.

The aim of the present invention is thus to propose a main aircraft landing gear bay roof configuration that wholly or partly resolves this problem.

### SUMMARY OF THE INVENTION

Thus, the invention relates to an aircraft landing gear bay roof, the roof being intended to form a pressurization barrier between a pressurized upper compartment and a landing gear bay for the housing of a landing gear, the roof comprising a roof wall forming the pressurization barrier, the roof wall being held by longitudinal gantries to which it is linked and which extend over the whole length of the roof wall, the roof wall comprising a lower face intended to be installed inside the landing gear bay and an upper face intended to be installed outside the landing gear bay, in which at least one of the gantries is installed against the lower face of the roof wall.

The installation of one or more gantries in the gear bay makes it possible to free up a space above the bay roof for the passage of systems that have to run longitudinally, for example air-conditioning systems. In particular, a shifting of a certain number of gantries under the wall of the landing gear bay roof also allows for the intercostal beams which transversely link the gantries, and constitute an obstacle to the running of the systems, to be shifted under the membrane.

The roof wall can comprise a first and a second reinforced structure, spaced apart from one another in a transverse direction of the roof, and a deformable part linking the first and the second reinforced structures by being interposed therebetween and the gantries can comprise:

a first lateral gantry installed at the interface between the first reinforced structure and the deformable part,

a second lateral gantry at the interface between the second reinforced structure and the deformable part, and

at least one central gantry supporting the deformable part.

The first and second lateral gantries can be installed against the upper face of the roof wall and the central gantry or gantries can be installed against the lower face of the roof wall.

The roof wall can comprise:

a main bulkhead extending in a longitudinal direction and comprising a front edge and a rear edge,

an inclined front bulkhead, rigidly linked to the front edge of the main bulkhead, and forming an obtuse angle with the main bulkhead, and

an inclined rear bulkhead, rigidly linked to the rear edge of the main bulkhead, and forming an obtuse angle with the main bulkhead.

The angle formed between the main bulkhead and the front bulkhead can lie between 110° and 170° and the angle formed between the main bulkhead and the rear bulkhead can lie between 100° and 170°.

The angle formed between the main bulkhead and the rear bulkhead on the one hand, and the angle formed between the main bulkhead and the front bulkhead on the other hand, can be substantially equal.

Each gantry situated against the lower face of the roof wall can mold to the form of the lower face of the roof wall over the whole length thereof.

According to an embodiment, the landing gear bay roof comprises at least two gantries against the lower face of the roof wall, in which the gantries installed against the lower face of the roof wall are linked together by intercostal beams.

The invention also relates to an assembly comprising a central wing box, intended to connect two wings respectively on either side thereof in the transverse direction, and a landing gear bay comprising a landing gear bay roof as previously described, in which the landing gear bay roof is linked to the central wing box by the gantries installed against the lower face of the roof wall by means of a pivot link of transverse axis.

The invention relates also to an aircraft comprising such an assembly.

### BRIEF DESCRIPTION OF THE DRAWINGS

Other particular features and advantages of the invention will become more apparent from the following description.

In the attached drawings, given as non-limiting examples:

FIG. 1 represents an exploded schematic view of an aircraft that can be the subject of the invention;

FIG. 2 represents, by a three-dimensional schematic view, an aircraft fuselage section that can be the subject of the invention;

FIG. 3 represents, by a schematic layout, a landing gear bay and its immediate environment, according to the state of the art;

FIG. 4 represents, by a view similar to that of FIG. 3, a landing gear bay and its immediate environment, according to an embodiment of the invention;

FIG. 5 represents, by a partial three-dimensional view, the lower structure of a landing gear bay roof according to an embodiment of the invention, and its immediate environment when it is installed in an aircraft;

FIG. 6 represents, by a three-dimensional view, a landing gear bay roof according to an embodiment of the invention and its immediate environment when it is installed in an aircraft;

FIG. 7 illustrates an aspect of the invention, by a view similar to that of FIG. 6.

### DETAILED DESCRIPTION OF THE PREFERRED EMBODIMENTS

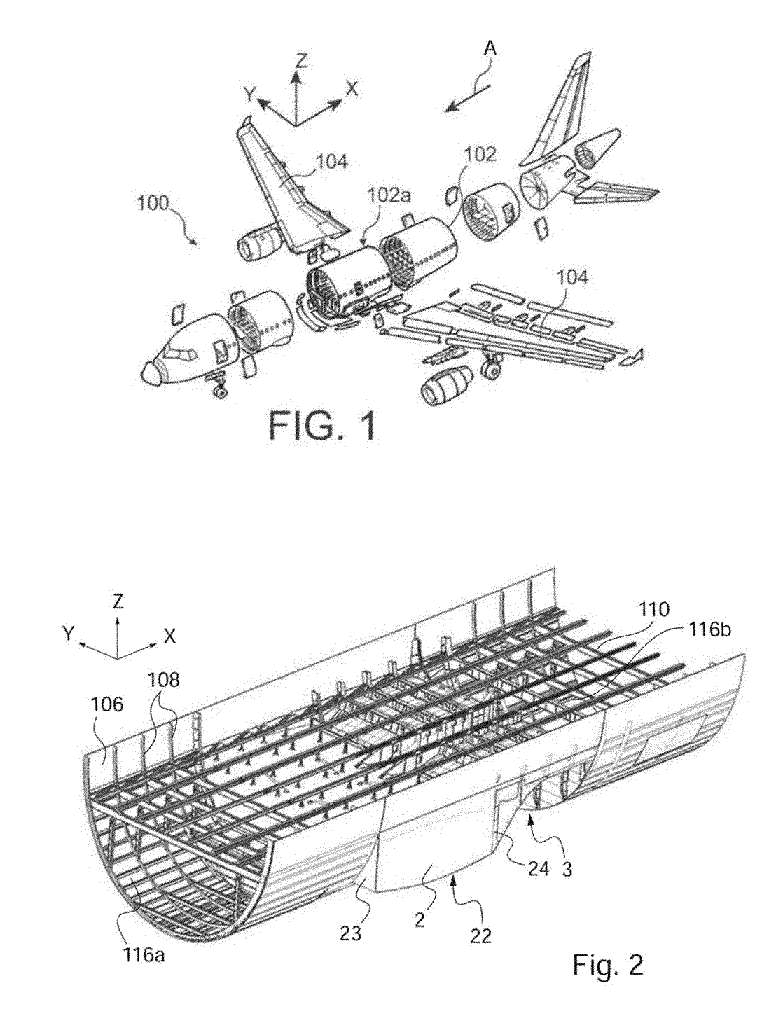

Referring to FIG. 1, an aircraft 100 is represented, in this case of the commercial airplane type.

Throughout the following description, by convention, X corresponds to the longitudinal direction of the aircraft, Y to the transverse direction, oriented transversely relative to the longitudinal axis, and Z to the vertical or heightwise direction, these three directions X, Y and Z being mutually orthogonal.

Also, the terms “front” and “rear” should be considered in relation to a direction of advance of the aircraft in flight, this direction being represented schematically by the arrow A.

The aircraft 100 comprises a fuselage 102 to which are attached two wings 104, at a fuselage section 102a.

The fuselage section 102a is specific to the invention, in that it comprises a landing gear bay provided with a landing gear bay roof according to the invention.

This fuselage section 102a is represented in more detail in FIG. 2. It comprises an outer fuselage skin 106, supported by substantially circular or elliptical fuselage frames 108. Within the section 102a, there is a floor 110 above which is arranged a pressurized upper compartment, namely the passenger cabin 112 of the aircraft.

Under the floor 110, in front of this section 102a, there is an underfloor pressurized first compartment 116a usually dedicated to the storage of technical equipment specific to the aircraft, and/or to the storage of merchandise.

The underfloor compartment 116a is delimited to the rear by a central wing box 2, also arranged under the floor 100. The central wing box 2 extends transversely over the whole width of the fuselage section 102a. It conventionally has an upper skin 21, a lower wall 22, a front wall 23, a rear wall 24, and lateral closure panels as well as internal rigidifying ribs. It is intended to connect the two wings 104, respectively on either side thereof in the transverse direction Y.

To the rear, the section 102a has a landing gear bay 3 for the housing of the two main landing gears, spaced apart from one another in the transverse direction Y.

The landing gear bay 3 is delimited to the front by the rear wall of the central wing box 2 incorporated in the section 102a. The rear wall 24 thus forms a front wall of the landing gear bay.

The fuselage has, in the bottom part of the landing gear bay 3, a downward opening allowing the raising and lowering of the landing gears, the opening being blocked by mobile hatches reconstituting the fuselage in the retracted position of the gears.

To the rear, the landing gear bay 3 is delimited by a substantially vertical rigid wall 31, separating the landing gear bay 3 from a second underfloor compartment 116b, also dedicated to the storage of technical equipment and/or to the storage of the merchandise.

At the top, the landing gear bay 3 is delimited by a landing gear bay roof 4 extending over the whole transverse width of the fuselage section 102a in which it is incorporated.

The roof 4, specific to the invention, is situated under the floor 110.

It is noted that, above this roof which forms a pressurization barrier, there is a pressurized intermediate compartment delimited between the floor 110 and this same roof. For the purposes of simplification of the figures, the passenger cabin and this pressurized intermediate compartment are associated with the same numeric reference 112. It therefore constitutes a pressurization barrier between the pressurized cabin 112 situated above this roof, and the non-pressurized landing gear bay 12 housing the main landing gears.

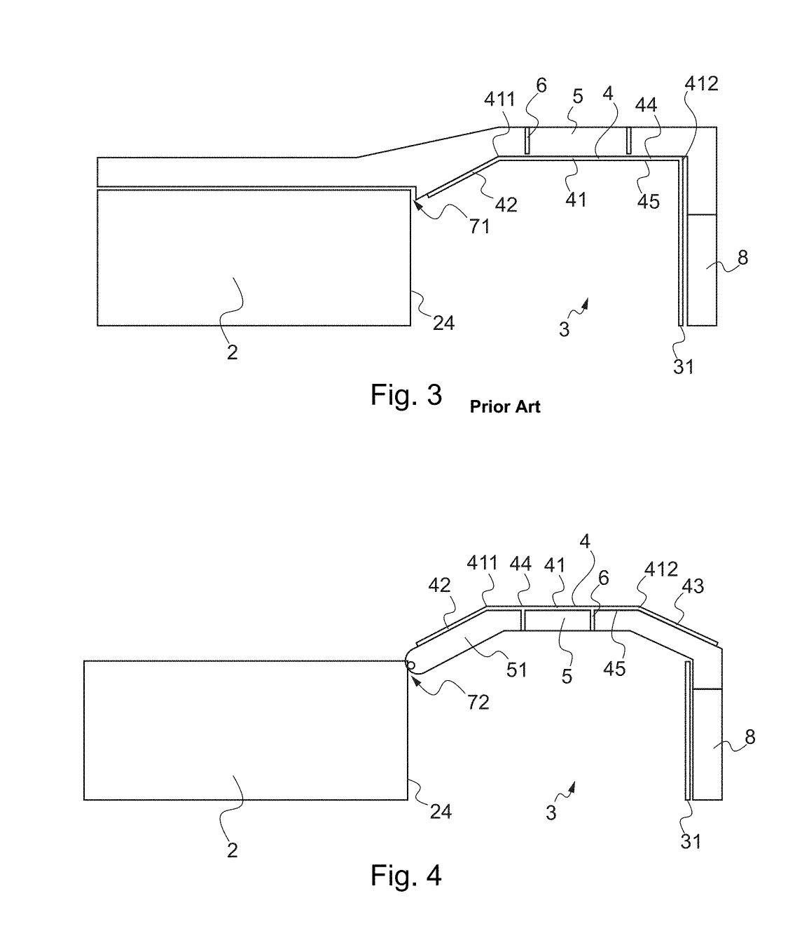

FIG. 3 schematically represents a landing gear bay 3 and its immediate environment, according to an embodiment according to the state of the art, for example according to the document FR3031080. The landing gear bay roof known in the state of the art comprises a roof wall which comprises, longitudinally, essentially two parts.

Thus, the roof wall comprises a main bulkhead 41 which extends in a longitudinal direction. The main bulkhead 41 is substantially horizontal, that is to say in a plane parallel to the longitudinal direction X and to the transverse direction Y, and orthogonal to the vertical direction Z.

The roof wall also comprises a front bulkhead 42, which is inclined relative to the main bulkhead 41.

The term inclined means that the front bulkhead 42 forms an angle with respect to the main bulkhead 41, but without being orthogonal thereto. The front bulkhead 42 nevertheless remains parallel or substantially parallel to the transverse axis Y. The angle formed between the main bulkhead 41 and the front bulkhead 42, measured inside the landing gear bay 3, is an obtuse angle. An obtuse angle denotes an angle strictly greater than 90° and strictly less than 180°. This angle can lie between 110° and 170°, in particular 160° or approximately 160°.

The front bulkhead 42 allows the landing gear bay roof 4 to be linked to the central wing box 2, in the top part of the rear wall 24. Indeed, because of the configuration of the wing, in particular its profile, the top edge of the rear wall is at a level lower than the plane of extension of the main bulkhead 41 of the roof.

The main part 41 is linked to the rigid wall 31 which forms the rear wall of the landing gear bay 3.

The roof wall comprises an upper face 44 and a lower face 45. The upper face 44 is the face intended to be installed in the pressurized zone, that is to say towards the passenger cabin 112. The lower face 45 is the face intended to be installed in the landing gear bay 3.

In order to support the roof wall, longitudinal gantries 5 are employed. The gantries 5 are elongate rigid structures, having a profile and a constitution conferring a great stiffness on them, particularly flexural in the longitudinal direction, that is to say about an axis oriented in the transverse direction Y. The gantries 5 are linked to one another, in the transverse direction Y, by so-called intercostal beams 6. The gantries 5 hold the roof wall by its upper face 44, and thus extend above the roof wall, outside of the landing gear bay 3.

The gantries 5 partly ensure the structural link with the central wing box 2.

To this end, a rigid link 71, called embedment link, is produced between each gantry 5 and the central wing box 2.

The gantries 5 are linked, to the rear, to a rear structure 8 of the aircraft.

FIG. 4 illustrates, by a view similar to that of FIG. 3, a landing gear roof according to an embodiment of the invention.

In a bay roof according to the invention, at least one gantry 5 supporting the roof wall 4 is positioned under the roof wall 4, against its lower face 45. Similarly, in the case where several gantries 5 are positioned against the lower face of the bay roof 4, the intercostal beams 6 linking the gantries 5 situated against the lower face of the bay roof 4 are also under the roof wall 4. The positioning of one or more gantries in the landing gear bay 3 thus free up a space for the passage of longitudinal systems above the landing gear bay roof.

In the particular embodiment of the invention represented here, the roof comprises, by comparison to the roof of FIG. 3, an inclined rear bulkhead 43. The angle formed between the main bulkhead 41 and the rear bulkhead 43, measured inside the landing gear bay 3, is an obtuse angle. This angle can lie between 100° and 170°. For example, this angle can lie between 110° and 160°, in particular 150° or approximately 150°. The angle between the main bulkhead 41 and the front bulkhead 42 on the one hand, and the angle between the main bulkhead 41 and the rear bulkhead 43 on the other hand, can be equal. The landing gear roof represented here thus has a general so-called “bridge-like” form, because it evokes the form of a bridge with a first rising part, a flat horizontal part, and a descending part.

The particular embodiment of the invention represented here also has the particular feature that the gantries positioned in the landing gear bay 3, under the roof wall 4, are linked to the central wing box 2 by a pivot link 72. The rigid link employed in the state of the art is not in fact optimal, in that it transfers to the landing gear bay roof a flexural moment linked to the deformation of the central wing box 2. The transfer of this flexural moment is not however desirable. The pivot link proposed here avoids or limits the transfer of this flexural moment, in that it makes it possible to decouple the behavior of the upper surface of the central wing box 2 from that of the gear bay.

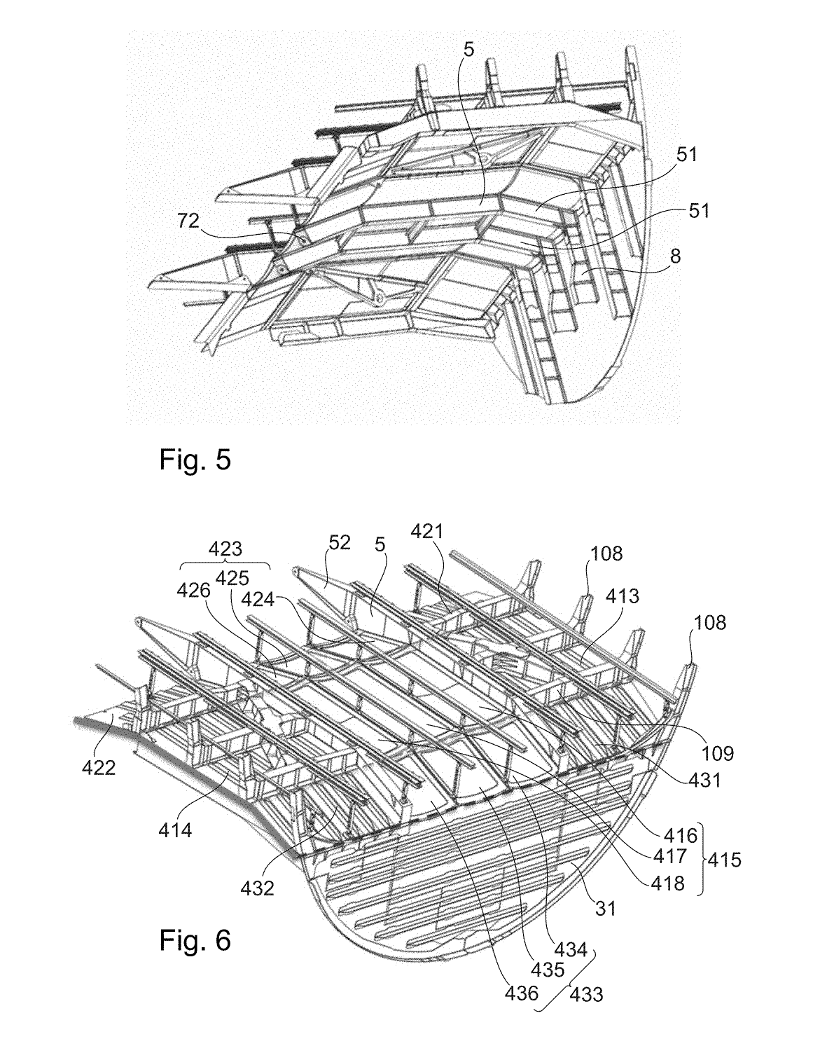

Described hereinbelow with reference to FIGS. 5 and 6 is an embodiment of the invention in which the landing gear bay roof 3 has, transversely, a particular construction.

FIG. 5 represents the lower structure of a landing gear bay roof according to an embodiment of the invention, and its immediate environment when it is installed in an aircraft. In the embodiment represented here, the longitudinal roof configuration corresponds to that of FIG. 4, that is to say with a “bridge-like” landing gear bay roof. Two gantries 5, namely two central gantries 51, are positioned under the roof wall 4, against its lower face. The central gantries 51 correspond to the gantries situated on either side of the longitudinal central axis of the aircraft equipped with the bay roof represented, or, in other words, of its median plane of symmetry. The central gantries 51 denote the gantries 5 which are at the interface between the membranes forming a deformable part, as described hereinbelow with reference to FIG. 6.

As represented in FIG. 6, the roof has a configuration which corresponds to that represented in FIG. 4, the roof wall 4 comprising in particular a main bulkhead 41, a front bulkhead 42 and a rear bulkhead 43.

The substantially horizontal main bulkhead 41 comprises, transversely in the example represented here, two rigid lateral zones 413, 414, and a flexible central zone 415.

Each of the lateral zones 413, 414 comprises:

a self-stiffened panel, made of metal or of composite material. The self-stiffened panel is located between several inter-frame spaces, that is to say that it extends longitudinally between several frames 108 of the fuselage section;

a bridge-formed lateral gantry 52, which extends longitudinally also at the level of the front and rear bulkheads described hereinbelow, interfaced with the respective feet 109 of the frames 108 between which the self-stiffened panel extends;

a fitting for taking up the main gear strut situated under the panel, or other mounting means allowing the articulation of a structural element of a landing gear;

a longitudinal beam linked to the take-up fitting, allowing a transfer of the forces to the feet 109 of the frame and to the lateral gantry 52.

The central zone 415 of the main bulkhead 41 extends between the lateral gantries 52. The central zone 415 comprises one or more flexible membranes. In the example represented here, the central zone 415 comprises three membranes 416, 417, 418. Between each membrane, there is positioned a central gantry 51, which extends longitudinally under the membranes as represented in FIG. 5, that is to say in the landing gear bay 3.

The central gantries 51 extend longitudinally also at the front and rear parts of the landing gear bay roof, and mold to the internal form of the roof The central gantries can thus have a “bridge-like” form. Links by intercostal beams 6 are produced between the central gantries 51 in order to stabilize them.

The front bulkhead 42, inclined relative to the main bulkhead 41 (for example by an angle of 20° to 40°, comprises, transversely in the example represented here, two rigid lateral zones 421, 422, and a flexible central zone 423.

The front bulkhead 42 is delimited at the front by the upper surface panel of the central wing box 2, and at the rear by a frame foot 109 which ensures the junction with the front edge 411 of the main bulkhead 41.

The two lateral zones 421, 422 of the front bulkhead 42 each comprise a self-stiffened panel made of metal or of composite material. The self-stiffened panel is, in the example represented here, located between two frames 108. The lateral gantry 52 described above extends at the level of the front bulkhead 42, above the latter.

The central zone 423 of the front bulkhead 42 extends between the lateral gantries 6. The central zone 423 of the front bulkhead 42 comprises one or more flexible membranes. In the example represented here, the central zone 423 comprises three membranes 424, 425, 426. The central gantries 51 described previously extend between the membranes 424, 425, 426, under the latter, molding to the internal form of the roof.

At the front, the link between the front bulkhead 42 and the central wing box 2 can be, wholly or partly, a pivot link of transverse axis.

In particular, in the example represented here, the central gantries 51 are pivot-linked to the central wing box 2, whereas the lateral gantries 52 are rigidly linked thereto. In fact, the consequences of the flexural moment of the central wing box 2 are greater over the deformable central part than over the rigid lateral parts.

The rear bulkhead 43, inclined relative to the main bulkhead 41 (for example by an angle of 20° to 40°), comprises, transversely in the example represented here, two rigid lateral zones 431, 432, and a flexible central zone 433.

The rear bulkhead 43 is delimited at the front by a frame foot 109 which ensures the junction with the rear edge 412 of the main bulkhead 41, and at the rear by the rigid wall 31.

The two lateral zones 431, 432 of the rear bulkhead 43 each comprise a self-stiffened panel made of metal or of composite material. The self-stiffened panel is, in the example represented here, located between two frames 108. The lateral gantry 52 described above extends at the level of the rear bulkhead 43, above the latter.

The central zone 433 of the rear bulkhead 43 extends between the lateral gantries 52. The central zone 433 of the rear bulkhead 43 comprises one or more flexible membranes. In the example represented here, the central zone 433 comprises three membranes 434, 435, 436. The central gantries 51 described previously extend between the membranes 434, 435, 436, under the latter, while molding to the internal form of the roof

Thus, the landing gear bay roof can be considered according to its segmentation into three longitudinally abutted walls, namely the front wall 42, the main wall 41 and the rear wall 43.

The roof can also be considered according to its transverse segmentation, according to which the roof comprises a first and a second lateral reinforced structure, composed of the lateral zones of the (front and rear main) walls of the roof, and a deformable part interposed between the lateral reinforced structures composed of the central zones of the (front and rear main) walls of the roof The first lateral reinforced structure comprises the lateral zones referenced 421, 413 and 431. The second lateral structure comprises the lateral zones referenced 422, 414 and 432. The deformable part comprises the central zones referenced 415, 423 and 433.

A lateral gantry 52 is disposed at the interface between the first lateral structure and the deformable part. It is positioned in the example represented here above the roof wall 4. It could be positioned, in an alternative embodiment, below the roof wall 4.

A lateral gantry 52 is disposed at the interface between the second lateral structure and the deformable part. It is positioned in the example represented here above the roof wall 4. It could be positioned, in an alternative embodiment, below the roof wall 4.

By considering the transverse segmentation of the roof, the deformable part comprises, for each wall of the roof, three sets of membranes linking the first and the second reinforced structures abutted transversely between the first and the second reinforced structures. According to alternative embodiments, the deformable part can be composed of one, two, four or five sets of membranes. A central gantry 51 is disposed at the longitudinal interface between each set of membranes of the deformable part. The central gantries 51 are, in the example represented here, disposed under the roof wall 4. The central gantries 51 mold to the form of the lower face 45 of the roof wall 4.

Obviously, many features of the invention described by way of example above can be produced in various ways without departing from the scope of the invention.

The membranes can be metallic or produced in a material based on an elastomer. The membranes advantageously have a rounded form that follows a transverse curvature. That allows for a better control of the deformation thereof, and offers a volume allowing the passage of aircraft systems.

The self-stiffened panels can be replaced by simple panels, of sufficient rigidity, for example panels on which stiffeners are added. That is the case whether the panels are metallic or of composite material.

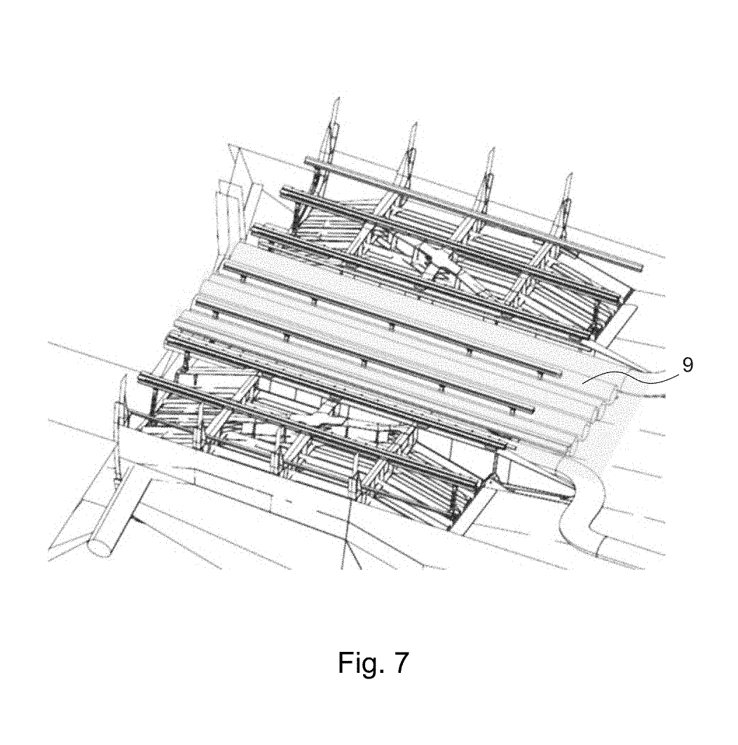

FIG. 7 illustrates one of the advantages of the invention. Systems of an aircraft comprising ducts 9 are installed so as to run longitudinally in an aircraft, above a landing gear bay equipped with the bay roof described with reference to FIGS. 5 and 6. The ducts 9 can for example be conduits for running electrical cables, hydraulic conduits or conduits of an air-conditioning system. The configuration of the roof, in particular the installation of the central gantries 51 under the roof wall 4, and therefore also of the intercostal beams linking the central gantries 51, frees up an obstacle-free space for the running of the ducts 9.

The running of the ducts 9 is facilitated all the more when the membranes of the central deformable part are curved so that it is possible to run ducts 9 in the longitudinal hollow formed by the curvature of the membranes.

The invention thus developed provides an aircraft landing gear bay roof which has an optimized configuration. In particular, the positioning of a certain number of gantries supporting the wall of the landing gear bay roof below the latter allows for an easy running of cables, ducts and other systems of the aircraft equipped with the landing gear bay roof This configuration proves particularly relevant in certain variants of the invention, in which the roof wall comprises a deformable central part composed transversely of several membranes or of several sets of membranes, the gantries positioned under the wall being able to be disposed at the interface between these membranes or groups of membranes.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft landing gear bay roof, the roof forming a pressurization barrier between a pressurized upper compartment and a landing gear bay for housing a landing gear, comprising:
a roof wall forming said pressurization barrier,
said roof wall being held by longitudinal gantries to which it is linked, and which extend over a whole length of said roof wall,
said roof wall comprising a lower face configured to be installed inside the landing gear bay and an upper face configured to be installed outside the landing gear bay,
wherein at least one of said gantries is installed against the lower face of the roof wall.

2. The landing gear bay roof according to claim 1, wherein the roof wall further comprises a first and a second reinforced structure, spaced apart from one another in a transverse direction of the roof, and a deformable part linking the first and the second reinforced structures by being interposed therebetween, in which said gantries comprise:
a first lateral gantry installed at an interface between the first reinforced structure and the deformable part,
a second lateral gantry at an interface between the second reinforced structure and the deformable part, and
at least one central gantry supporting the deformable part.

3. The landing gear bay roof according to claim 2, in which said first and second lateral gantries are installed against the upper face of the roof wall and the central gantry or gantries are installed against the lower face of the roof wall.

4. The landing gear bay roof according to claim 1, wherein the roof wall comprises:
a main bulkhead extending in a longitudinal direction and comprising a front edge and a rear edge,
an inclined front bulkhead, rigidly linked to the front edge of the main bulkhead, and forming an obtuse angle with the main bulkhead, and
an inclined rear bulkhead, rigidly linked to the rear edge of the main bulkhead, and forming an obtuse angle with the main bulkhead.

5. The landing gear bay roof according to claim 4, in which an angle formed between the main bulkhead and the front bulkhead lies between 110° and 170° and an angle formed between the main bulkhead and the rear bulkhead lies between 100° and 170°.

6. The landing gear bay roof according to claim 4, wherein an angle formed between the main bulkhead and the rear bulkhead, and an angle formed between the main bulkhead and the front bulkhead, are substantially equal.

7. The landing gear bay roof according claim 1, wherein each gantry situated against the lower face of the roof wall molds to a form of said lower face of the roof wall over an entire length thereof.

8. The landing gear bay roof according to claim 1, comprising at least two gantries against the lower face of the roof wall, wherein the gantries installed against the lower face of the roof wall are linked together by intercostal beams.

9. An assembly comprising a central wing box configured to connect two wings respectively on either side thereof in a transverse direction, and a landing gear bay comprising a landing gear bay roof according to claim 1, wherein the landing gear bay roof is linked to the central wing box by the gantries installed against the lower face of the roof wall by means of a pivot link of transverse axis.

10. An aircraft comprising an assembly according to claim 9.
